(19) United States
(12) Patent Application Publication
(10) Pub. No.: US 2010/0032448 A1
(43) Pub. Date: Feb. 11, 2010

(54) DEVICE FOR AUTOMATICALLY DISPENSING AND EJECTING PRODUCTS STORED IN PARALLEL LONGITUDINAL ROWS

(75) Inventors: Rupert Katritzky, Monaco (FR); Bruce Piggott, Hertfordshire (GB); David Painter, Norfolk (GB); Luc Hasenfratz, Haguenau (FR); Guillaume Nogues, Mareil Sur Loire (FR); Jérémy Fontenay, La Fieche (FR); Jean-Louis Connier, La Fleche (FR)

Correspondence Address: YOUNG & THOMPSON, 209 Madison Street, Suite 500, Alexandria, VA, 22314, US

(73) Assignee: ARX, Bazouges Sur Le Loir (FR)

(21) Appl. No.: 12/279,730

(22) PCT Filed: Mar. 6, 2007
(86) PCT No.: PCT/EP2007/052069

§ 371 Date: Apr. 1, 2009

(30) Foreign Application Priority Data
Mar. 6, 2006 (FR) 06/01970

(51) Int. Cl. B65G 1/10

(52) U.S. Cl. 221/258

(57) ABSTRACT

A device (10) for automatically dispensing and ejecting products (B), includes at least one tray (P) having a series of channels (C), which are separated by a partition (34), stop elements (40), and a series of controlled ejection members, characterized in that each ejection device includes a movable ejection plate which is able to act, directly or indirectly, on the lower face of at least the first front product so that it can be ejected, and an actuator (54) which is associated with each channel (C), which is mechanically connected to the ejection plate and which includes a movable element (60) which is able to be operated between a rest position and a working position for ejection purposes.

### TECHNICAL FIELD OF THE INVENTION

The present invention relates to a device for automatically dispensing and ejecting products.

### PRIOR ART

The present invention relates more particularly to a device for automatically dispensing and ejecting products, such as for example boxes of medicines, stored in parallel longitudinal rows, that comprises at least one rack, or tray, comprising:
a series of transversely adjacent channels, or corridors, each able to hold a row of products, all in the same plane as each other, each separated from its neighbor or neighbors by a longitudinal partition perpendicular to said plane, and each having a flat base on which the products rest;
stop means at the forward longitudinal end of each channel against which the forwardmost product in each row is retained by longitudinal abutment;
and a series of controlled ejector means, of which each corresponds to one channel and is able to act on said forwardmost product in order to pass it vertically over said stop means for its ejection from the channel.

The object of the invention is to provide a new form of controlled ejector means for a device of this type, that will among other things simplify the control of the simultaneous ejection of multiple products.

### SUMMARY OF THE INVENTION

For this purpose the invention provides a device characterized in that each ejector device comprises:
a movable ejector plate capable of acting, directly or indirectly, on the lower face of at least said forwardmost product in order to eject it;
and an actuator which corresponds to each channel, is connected mechanically to said ejector plate and comprises a movable member that can be controlled between a rest position and a working position in order to eject it.
   Other features of the invention are as follows:
each ejector device comprises a motorized drive member able to act on said movable member in the working position in order to produce a generally upward vertical movement of the ejector plate;
the body of the actuator is connected to the ejector plate, and the motorized drive member is able to act on said movable member in the working position to produce a generally upward vertical movement of the actuator, and hence of the ejector plate to which the actuator is mechanically connected;
the movable ejector plate is a plate generally parallel to said plane with an upper face capable of acting, directly or indirectly, on the lower face of at least said forwardmost product;
the movable ejector plate is a flexible plate that is elastically deformable between a low or rest position, to which it is returned elastically, and a high or ejection position, in which it extends upward vertically;
the body of the actuator is mounted on the upper face of the flexible ejector plate, and the upper face of the casing of the actuator is able to act on the lower face of said forwardmost product, by extending upward, notably through a corresponding window facing it through a base plate common to all the channels of a rack;
the movable ejector plate is a plate that is perpendicular to said plane and whose upper longitudinal edge is able to act on the lower face of at least said forwardmost product in order to eject it;
each intermediate partition is a separating plate mounted movably between a high active position of separation in which it projects vertically to separate two adjacent channels and a low retracted position, each movable separating plate is able to form a movable ejector plate whose upper longitudinal edge is able to act on the lower face of at least said forwardmost product in order to eject it, and said motorized means are able to drive each separating plate acting as an ejector plate between its low retracted position and a high ejection position;
said high ejection position is an intermediate position between said low retracted position and said high separating position;
the actuator is an electromagnet whose movable core is controllable between a withdrawn rest position and an extended working position in which it can be acted on by the motorized drive member;
the motorized drive member is a member common to all the ejector means which is able to act simultaneously on all of said movable members which are in the working position, in order to simultaneously eject said forwardmost products contained in the corresponding channels;
the motorized actuating member is a transverse drive bar that is driven, by an ejection control motor, between a low or rest position and a high or ejection position in which it acts simultaneously on said movable members in the working position;
the motorized actuating member is a transverse drive bar that is rotated about its axis, by an ejection control motor, between an angular rest position and an angular working position, and that carries a series of radial levers coupled in rotation to the drive bar and each able to act on a movable member in the working position of a corresponding channel;
each radial lever comprises an arm which, in the angular rest position of the drive bar, acts as a stop located at the forward longitudinal end of each channel, against which the forwardmost product of each row is retained in longitudinal abutment.

### BRIEF DESCRIPTION OF THE FIGURES

Other features and advantages of the invention will become apparent on reading the following detailed description, for which the reader should refer to the appended drawings illustrating, by way of non-restrictive example, a number of embodiments and variants of a device in accordance with the teachings of the invention, in which:

FIG. 1 is a three-quarter front top perspective view of a first embodiment of a device that is fitted, by way of example, with only its lower rack and an upper rack;

FIG. 2 is a top perspective view, from another angle, of the device shown in FIG. 1;

FIG. 3 is a top elevation view of the device shown in FIG. 1;

FIG. 4 is a three-quarter rear bottom perspective view of the device shown in FIG. 1;

FIG. 5 is a perspective view of the lower base plate;

FIG. 6 is a perspective view of the base plate of the upper rack;

FIG. 7 is perspective view illustrating the assembly of the base plate with its front printed circuit board, rear printed circuit board and backing plate;

FIG. 8 is a perspective view of a front printed circuit board with its flexible tongues;

FIG. 9 is a perspective view of a rear printed circuit board fitted with some of its main components;

FIG. 10 is a detail view of a separating plate forming a separating partition;

FIG. 11 is a detail view illustrating a separating plate in the active position;

FIG. 12 is a perspective view on a larger scale of the top right-hand area of FIG. 1 showing only certain components;

FIG. 13 is a view similar to that of FIG. 12 showing the bottom right-hand area of FIG. 1;

FIG. 14 is a view of the bottom right-hand area of FIG. 13, from another angle of view;

FIG. 15 is a view similar to that of FIG. 14 showing only certain components;

FIG. 16 is a perspective view of an electromagnet with its movable rod extended in the working position;

FIG. 17 is a schematic perspective view of a second embodiment of a device,

FIG. 18 is a front view on an enlarged scale of the top area of the device shown in FIG. 17;

FIG. 19 is a perspective view of one of the modules fitted to the device shown in FIG. 17, this time illustrated without the adjacent separating plate;

FIG. 20 is a detail view on an enlarged scale of the front portion of the module seen in FIG. 19, this time shown fitted with a lateral adjacent separating plate;

FIG. 21A is a top view of the module shown in FIG. 19 with its central ejector plate and its electromagnet in the rest position;

FIG. 21B is a side view of FIG. 21A;

FIG. 21C is a view similar to that of FIG. 21B in which the central plate is in the high ejection position;

FIG. 21D is a view similar to that of FIG. 21C showing the rest position of the central plate when the electromagnet is not energized;

FIGS. 22A-22D are views similar to those of FIGS. 21A-21D which show a variant of the radial ejector levers;

FIGS. 23A-23C are views similar to those of FIGS. 21A-21C showing a variant of the control means of the ejector plate;

FIG. 23E is a view similar to that of FIG. 23C showing the central plate of the module in its highest position where it acts as a separating plate; and

FIGS. 24A-24D are views similar to those of FIGS. 21A-21D showing a variant of the ejector means.

### DETAILED DESCRIPTION OF THE FIGURES

In the following description, identical, similar or analogous components will be denoted by the same reference figures.

To assist with interpreting the description and the wording of the claims, the terms “vertical”, “longitudinal”, and “transverse” will be used with reference to the three axes V, L, T indicated in the figures.

The forward direction is the direction of the L axis of the axis system indicated in the figures.

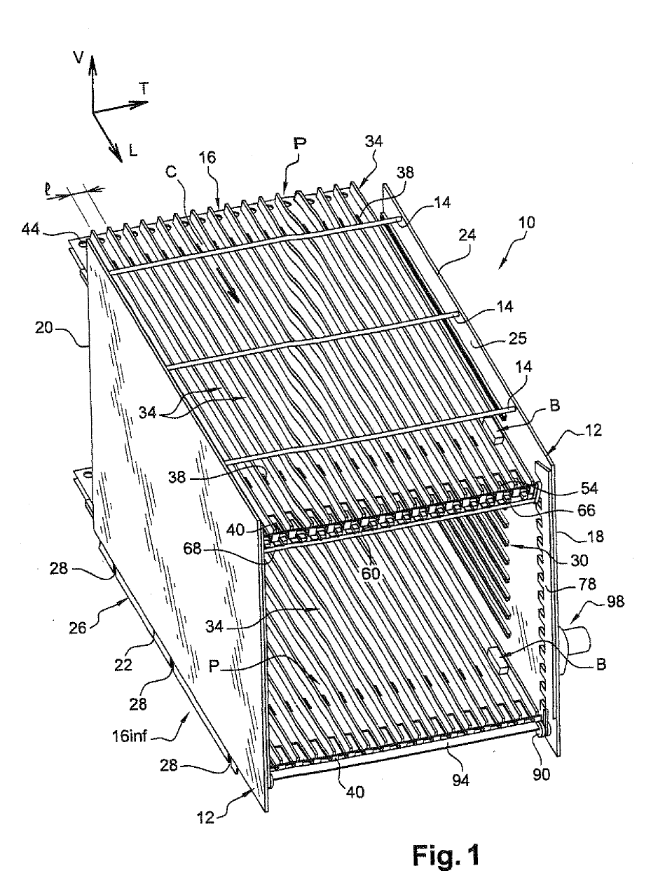

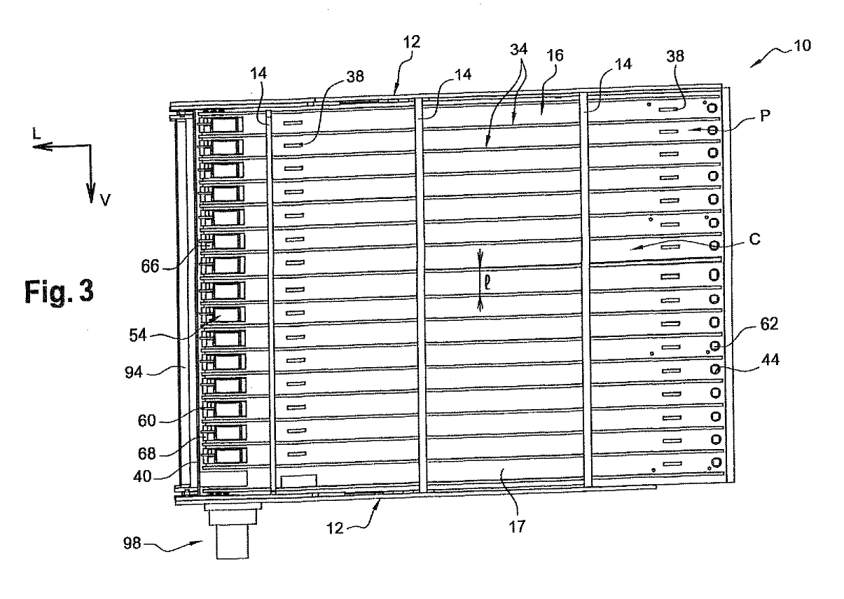

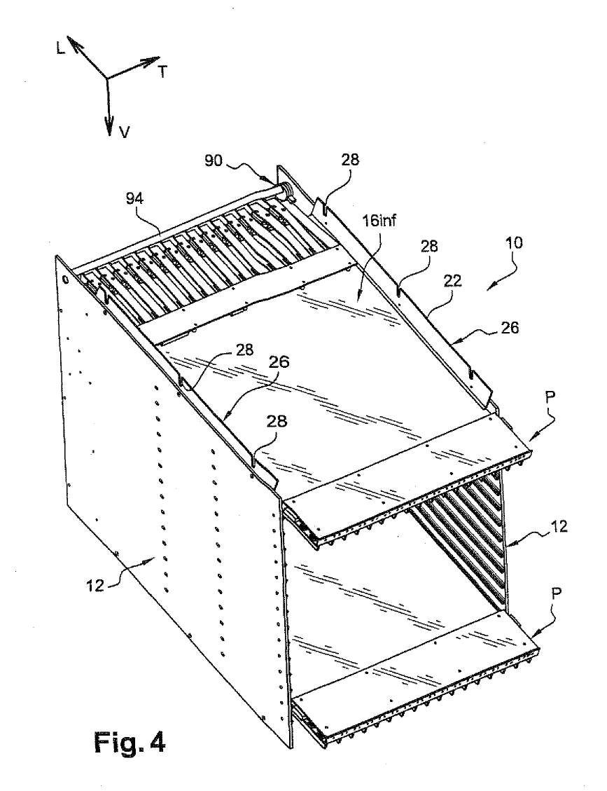

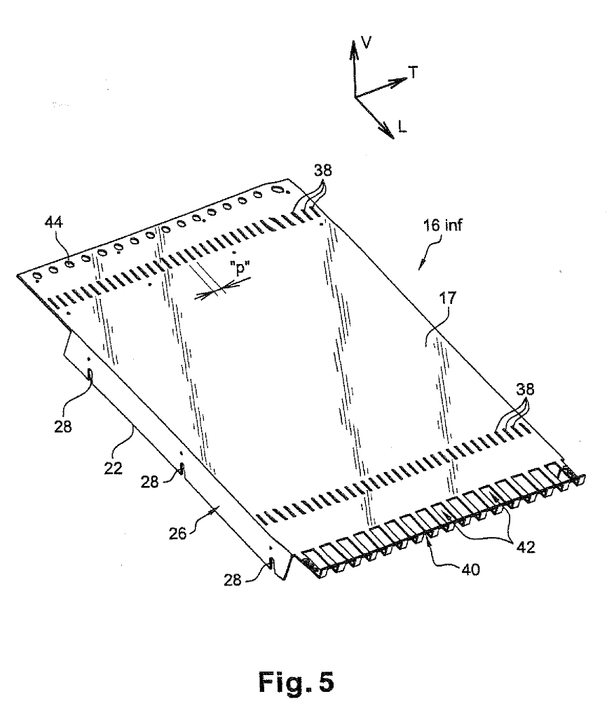

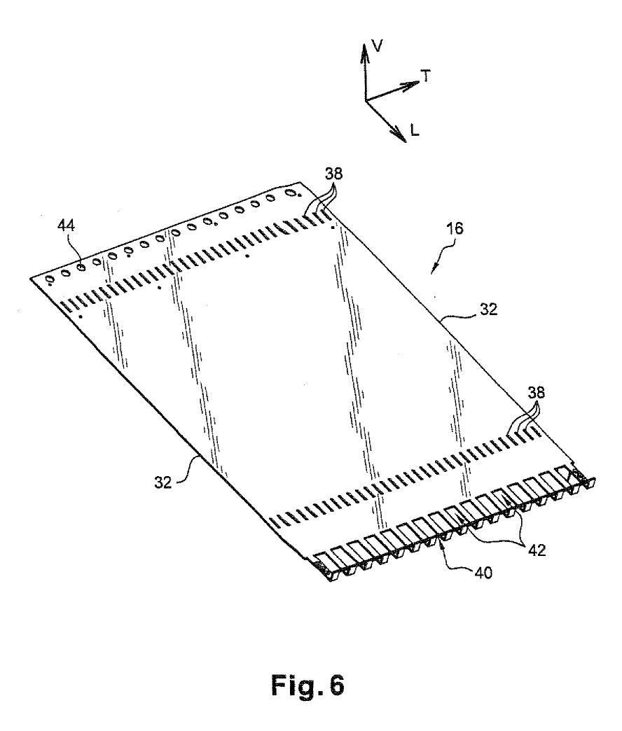

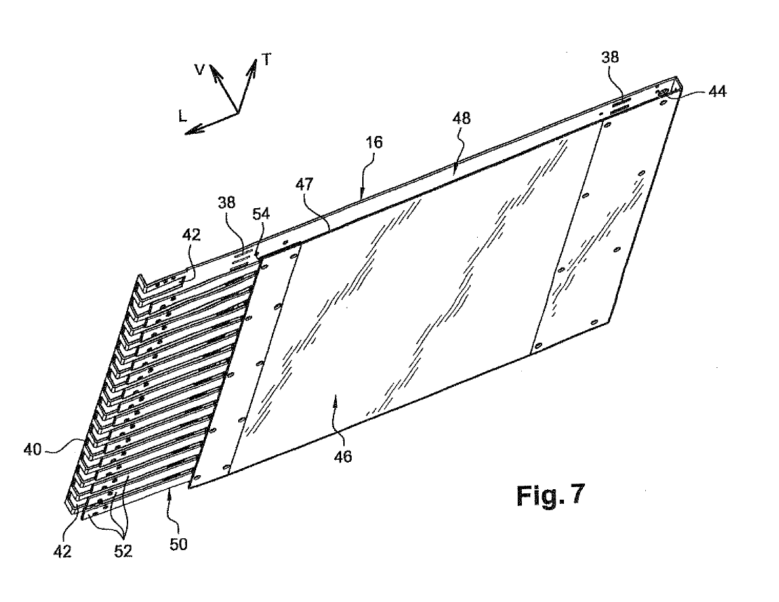

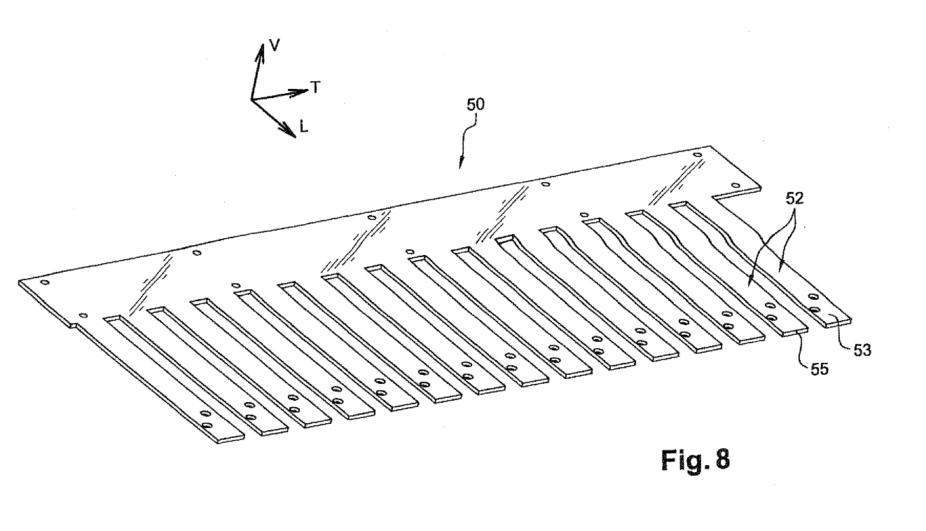

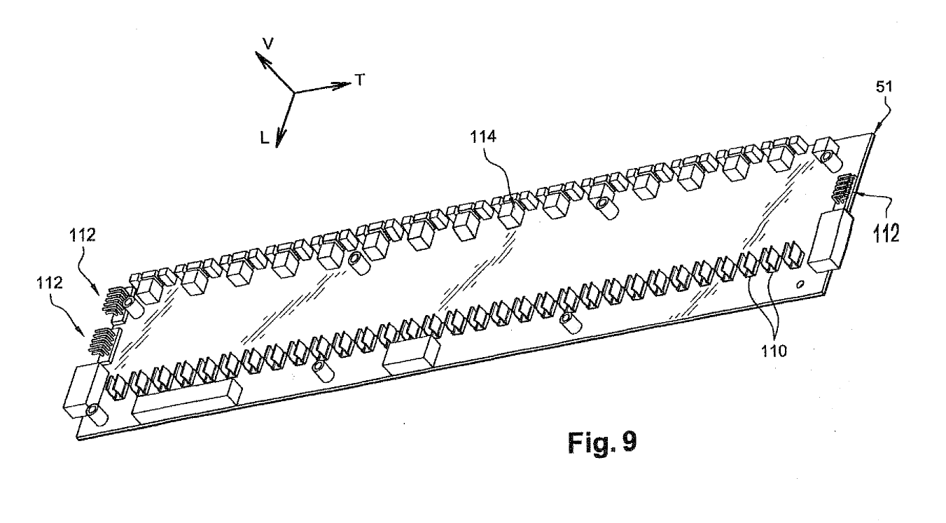

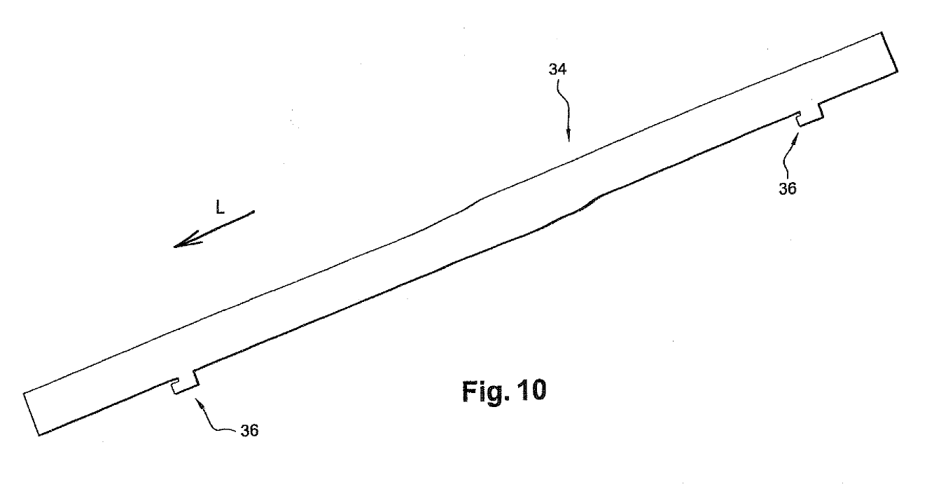

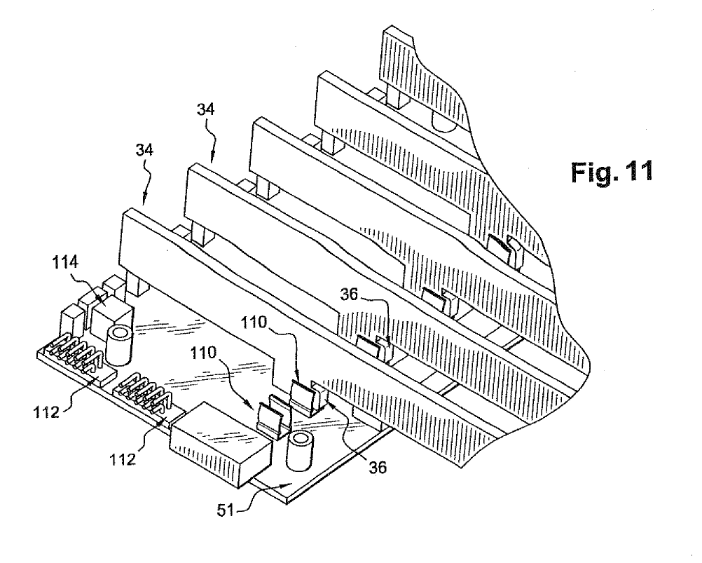

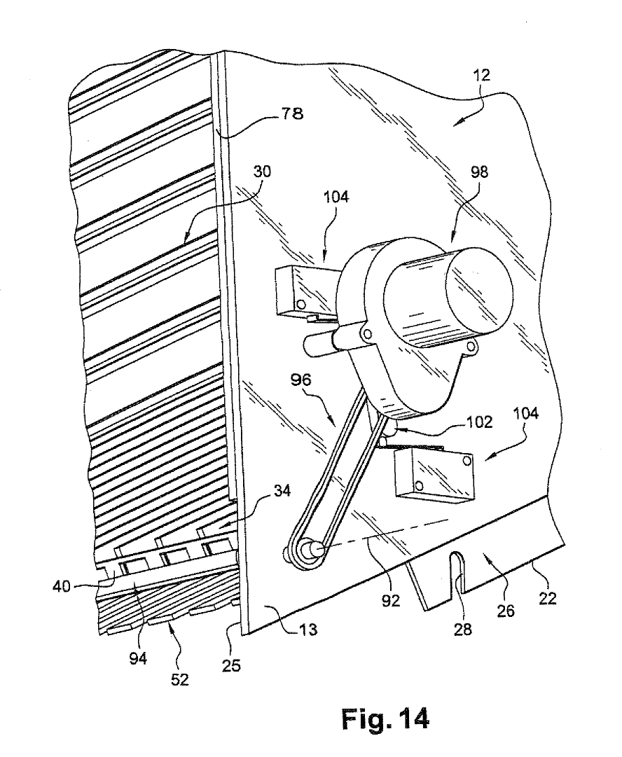

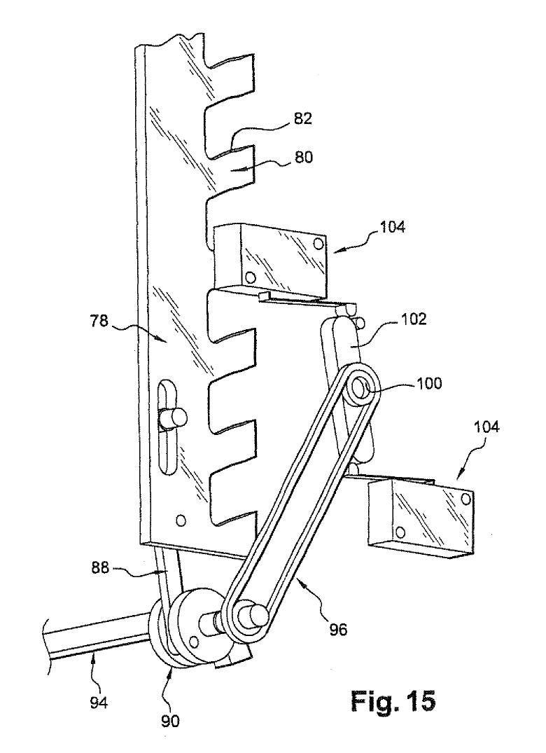

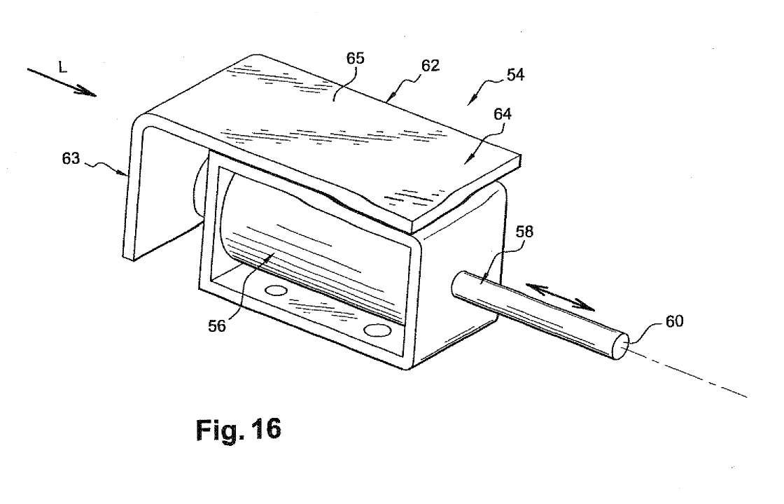

Apart from certain motorized drive elements, the device 10 in the first embodiment illustrated in FIGS. 1-16 exhibits a general symmetry of design about a vertical longitudinal midplane PVL indicated in FIG. 3.

The device 10 illustrated in FIG. 1 has a frame capable of accepting multiple racks P arranged one above the other for dispensing and ejecting products, such as in this case boxes B of medicines.

The device comprises two vertical side plates 12 of longitudinal orientation which, to form the frame or structure, are connected to each other partly by three coplanar transverse upper connecting bars 14 to which the side plates are screwed, and partly, at the bottom, by a lower transverse base plate 16inf to which the side plates 12 are screwed.

Each side plate 12 is defined by a front vertical edge 18 and a rear vertical edge 20 and by a lower longitudinal edge 22 and a parallel upper longitudinal edge 24, the latter two edges being inclined to the horizontal by an angle alpha (a).

The lower base plate 16inf and the three upper connecting bars 14 also extend in parallel planes inclined by the angle alpha.

The lower base plate 16inf comprises two longitudinal side lugs 26 to which the side plates are screwed. The lugs 26 extend vertically down beyond the lower edges 22 of the side plates 12 and each has three indentations 28 that are open vertically downward and are set out at the same longitudinal pitch as the three upper connecting bars 14.

This type of construction makes it possible to stack two devices 10 vertically by engaging the connecting bars 14 of the lower device in the indentations 28 of the upper device, with the side lugs 26 of the lower base plate 16inf of the upper device fitting transversely between the inner faces of the upper parts of the side plates 12 of the lower device.

On its inner face 25, each side plate 12 can be provided with a series of vertically stacked parallel runners 30 inclined by the angle alpha. A pair of opposite side runners 30 of the same height, opposite each other, are able to accommodate a base plate 16 of a rack P which, when placed in position in its two runners 30, is thereby oriented with the inclination alpha relative to the horizontal.

To this end, each base plate 16, other than the lower base plate 16inf, is bounded by two longitudinal side edges 32 accommodated in the two runners 30 of the corresponding pair.

The runners 30 may be permanently fitted to the side plates 12 or be removable and put in position, in pairs, when it is wished to install base plates 16 to create the corresponding racks.

For this purpose the side plates 12 have slots in which positioning and mounting pins on the runners 30 are received.

The upper face 17 of each base plate 16, 16inf forms a plane which is inclined from the rear to the front by the angle alpha relative to the horizontal and forms a flat base. A box B placed on the upper face 17 of a base plate 16, 16inf is therefore made to slide down by gravity from the rear to the front in the general longitudinal direction L.

In this embodiment, and in order to create a rack P forming a unitary subassembly, each inclined base plate comprises a series of vertical longitudinal separating plates 34 which divide the space above the upper face 17 of the base plate into a series of inclined longitudinal channels C or corridors, each of which can house a series of boxes in single file arranged longitudinally and side by side and all of approximately the same transverse width. In particular, all the boxes contained in a given channel are identical and contain the same medicine.

A separating plate 34 in place extends in a longitudinal vertical plane perpendicular to the inclined plane of the upper face 17 and forms a is partition separating two adjacent channels C.

Each channel C is thus open vertically upward and is bounded by the opposing inner faces 35 of two consecutive separating plates and by that portion of the upper face 17 which lies between these two plates 34.

In this embodiment each separating plate 34 is fixed removably disconnectably to the base plate 16, 16inf.

For this purpose each separating plate 34 comprises, in its lower longitudinal edge, a pair of L-shaped lugs 36 forming hooks in the vicinity of the front and rear longitudinal ends of the separating plate 34. These lugs point forward and fit into a pair of slots 38 which are in longitudinal alignment and pass all the way through the thickness of the base plate.

Each base plate comprises a series of x (here x=33) pairs of slots 38 which are aligned longitudinally in pairs and in the present case are spaced out transversely at a constant pitch “p”.

As is shown by way of example in FIG. 3, the upper base plate 16, like the lower base plate 16inf, is in the present case provided with only seventeen partitions 34 spaced out at regular intervals from the right to the left at a constant pitch of “2p”, thus defining sixteen adjacent channels C, fifteen of which are of the same width “/”.

This gives a modular design of each rack P of channels C for the storage and dispensing of boxes B, consisting of a base plate 16, 16inf with its separating plates 34, with a variable number of channels C of variable widths “/” depending on the number of partitions 34 used and on their various transverse positions on the base plate.

To hold back the boxes B stored in the different channels C, each base plate comprises a transverse front stop bar 40 which in the present case is fixed and is higher than the upper face 17 of the base plate.

In this way, the forwardmost box in each row of boxes contained in a channel C abuts longitudinally forward and downward by gravity against the opposing portion of the stop bar 40, which extends transversely across the front open end of the corresponding channel. The stop bar 40 is in this case formed integrally with the base plate 16, 16inf from cut and bent sheet metal.

In the vicinity of its front longitudinal end, the base plate comprises, in addition to the transverse front stop bar 40, a series of sixteen longitudinal cutouts 42 which thus form windows whose function will be explained below.

Each of the sixteen windows 42 also extends vertically almost as far up as the common transverse stop bar 40.

In the vicinity of its rear longitudinal end, the base plate also comprises a series of sixteen through holes 44 whose function will be explained below.

Each common base plate 16, 16inf is backed, on the underside, by a parallel backing plate 46 to which it is attached by means of intermediate distance pieces so that an intermediate cavity 48 of approximately constant height is defined between these two plates 16 (16inf) and 46 of a rack P in order to house various components.

In the vicinity of its front end, the backing plate 46 comprises on its upper face 47 a front printed circuit board 50 whose front free end section is cut to divide it into sixteen parts forming front longitudinal tongues 52, each projecting longitudinally forward beyond the front transverse edge of the backing plate, level with a corresponding window 42 in the base plate.

The dimensions and thickness of each tongue 52 of the front printed circuit board 50 give each tongue 52 elastic deformability, particularly in the upward direction, to make it a flexible tongue.

In this embodiment, each flexible tongue 52 carries on its upper face 53 an activator which in this case consists of an electromagnet 54, the axis of which is oriented longitudinally, and which comprises in particular a longitudinal cylindrical coil body 56 and a movable core or rod 58 which projects longitudinally in the forward direction. The free end section 60 of the movable rod 58 is able to occupy a forward extended longitudinal position termed the working position, and a rearward retracted longitudinal position termed the rest position. The rod 58 is returned to its rest position elastically.

The coil body 56 of the electromagnet 54 is housed in a casing 62 whose longitudinal upper wall 64 defines a planar upper face 65 that is parallel to the plane of the upper face 53 of the flexible tongue 52 and that, in the rest (undeformed) position of the flexible tongue 52, is withdrawn slightly below the plane of the upper face 17 of the base plate 16, 16inf in such a way that it is not an obstacle in the channel C in question and thus allows the forwardmost box to reach the transverse front stop 40.

When the coil of an electromagnet 54 is energized to extend the movable rod 58 longitudinally forward to its working position, at least its free front end section 60 projects longitudinally forward beyond the transverse stop 40, and beyond the front transverse end edge 55 of the flexible tongue 52 to which the electromagnet 54 is attached.

On its free front end section, each flexible tongue 52 also supports a sensor unit 66 which, like the front section of the flexible tongue 52, is level with a window 42 in the base plate, set back from the common transverse stop 40.

Each sensor unit 66 has as its first function the detection of the presence of a box B in the forwardmost longitudinal position in abutment against the stop 40, level with a window 42 and, in one possible variant, the extended front longitudinal working position of the section 60 of the movable rod 58, or the rear longitudinal rest position of this section when the coil 56 of the electromagnet 54 is not energized.

The position of the electromagnet 54 on the flexible tongue 52, the relative position of the latter with respect to a window 42 in the base plate, and the total vertical dimension of the electromagnet 54 are such that, when the tongue 52 is in its unbent rest position, in which it is in the same plane as the front printed circuit board 50, the upper face 65 of the casing 62 is vertically slightly below the upper face 17 of the base plate.

The dimensions of the electromagnet 54 are moreover such that it can “rise” vertically through the window 42 in such a way that the board 64 with its upper face 65 projects vertically through the window 42 into the corresponding channel C, particularly in order to act on the lower face of a box B present in this channel and in abutment against the stop 40.

In such a “raised” position of the electromagnet 54, the rear vertical plate 63 forms a stop to the next box which is arrested by this plate and temporarily cannot reach the stop 40.

Besides an electromagnet 54, the controlled ejector means for ejecting a forwardmost box contained in a channel C—in order to pass it vertically over the common transverse stop 40 and so eject it from the channel C—comprise a transverse motorized drive bar 68 which is capable of acting on the free end section 60 of each movable rod 58 of the electromagnet 54 in the extended working position in order to bring about a vertical and generally upward movement of this movable rod 58 as it lifts the section 60.

Any upward vertical action on a rod 58 will cause a corresponding upward vertical movement of the entire electromagnet 54 because of the flexibility of the flexible tongue 52 supporting it.

In this embodiment each flexible tongue 52 acts as a movable ejector plate that is generally parallel to the base plate supporting it and whose upper face 53 is able to act, indirectly via the electromagnet 54 in the present case, on the lower face of the forwardmost box situated level with the upper face 65 and with the window 42.

The motorized transverse bar 68 is in this case common to all the channels C of a given rack P, in other words is able to act simultaneously on all the end sections 60 of the movable rods or members 58 of the electromagnets 54 which are in the front longitudinal working position.

Each free end 72 of an ejector bar 68 is guided as it slides in a generally vertical upward or downward movement in a slot 74 in a guide piece 76 mounted for this purpose on the inner face 25 of a side plate 12.

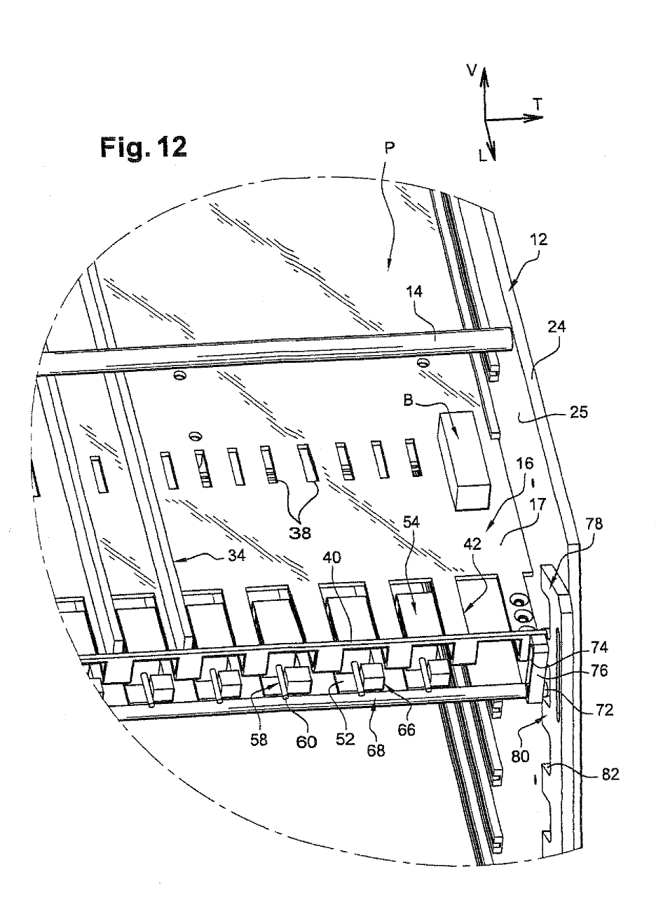

At rest, each bar 68 is pulled down vertically by gravity to the bottom end of a slot 74 as illustrated in FIGS. 1 and 12.

In order to move a drive bar 68 generally vertically upward, the device comprises in the present case, by way of example, two movable toothed slats 78, each mounted and guided so as to slide vertically upward on the inner face 25 of a plate 12.

Each toothed slat 78 comprises a series of teeth 80 extending longitudinally rearward and each defining an upper face 82 for acting on the free end section 72 of a drive bar 68 located above it.

In order to move the two toothed slats 78, notably vertically upward and simultaneously, each slat 78 is connected, in a pivoting manner about a transverse pin 86, to an intermediate lever 88 driven by an eccentric 90 that rotates, about a transverse axis 92, relative to the side partition 12.

The two eccentrics 90, and therefore the two levers 88 and the two toothed slats 78, are driven simultaneously in both directions by a transverse synchronizing plate 94 connected to both opposite eccentrics 90. The plate 94 also operates as a motorized drive bar for the lower rack formed by the plate 16inf.

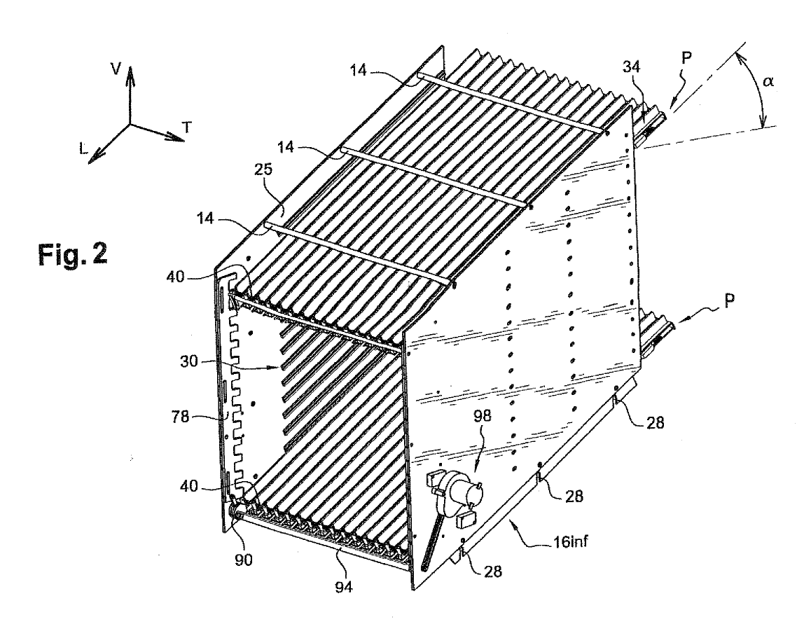

In order to turn the eccentrics 90, and hence drive the toothed slats 78 vertically in both directions, the eccentrics 90 are driven by a belt 96 which in turn is driven by a geared motor 98. These components are mounted on the outer side face 13 of the vertical plate 12 visible on the right-hand side of FIGS. 1 and 2.

The motorized shaft (not shown) of the geared motor 98 is capable of turning the wheel 100 acting on the belt 96, and simultaneously a rocker 102 capable of acting on two diametrically opposite sensors 104 which sense the angular position of the rocker 102 and hence that of the eccentrics.

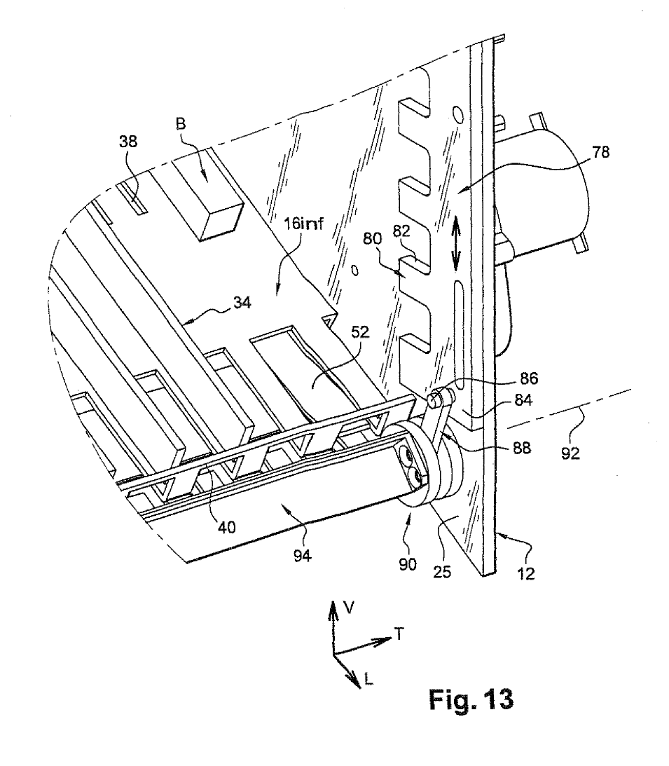

When viewing FIGS. 12 and 13, the counterclockwise turning of the eccentrics 90 first causes a generally vertically upward movement of the intermediate levers 88, and hence of the toothed slats 78 which act via the upper faces 82 of the teeth 80 on the drive bars 68 present in the device, and of which each one acts itself on all the sections 60 of the extended movable rods 58 in the working position of the corresponding rack P.

Rotation of the eccentrics 90 beyond this point then brings about a vertical downward movement of the slats 78 and therefore allows the ejector bars 68 to return by gravity to their rest position.

The construction described above thus offers a very high degree of modularity, both in the general construction of the device 10 which can comprise up to fourteen stacked racks P, including the lowest rack made from the lowest base plate 16inf, and by the construction of each rack, in which the number of channels C and the width of the different channels C can be varied.

The construction also makes it possible to bring about, in the course of an ejection cycle, by means of a single geared motor 98, the simultaneous ejection of all the desired products of which a “forwardmost” box is level with one or more electromagnets 54 which act as individual ejection actuators.

By way of a variant (which is not illustrated), in order to move the two toothed slats 78, especially vertically upward and simultaneously, the assembly 90, 98 can be replaced by a central pneumatic or electric actuator acting directly on a transverse synchronizing plate 94 which, for this purpose, is mounted on the bottom ends of the toothed slats.

It will be observed that, for a corridor of “great” width “/”, and depending on the weight of the box B to be ejected, it is possible to act simultaneously on the lower face of this box by means of the upper face 65 of several—for example two—adjacent electromagnets 54 whose movable rods 58 are moved simultaneously to the extended working position.

Each electromagnet 54 is advantageously powered electrically only to extend its movable rod 58 and it does not work under load, or at any rate with only a very small load in the sense that the ejection load of simply lifting the boxes is exerted and applied by the geared motor 98.

With this construction it is possible to make the actuators represented by the electromagnets 54 very small and weak so that not only is their cost and weight reduced but they also draw only very small currents for their is control.

The modularity of each rack P can be combined, for the purposes of controlling the dispensing and ejection of the products, with means, for each rack P, for automatically “detecting” the presence of each separating plate 34 in the active or separating partition position, in such a way as to produce and supply corresponding signals that can be processed by an electronic dispensing control unit (not shown) connected to the device 10, or to several devices 10 assembled together.

In the first embodiment, in which each separating plate 34 is a removable plate disconnectable between its active position, in which it separates two adjacent channels C and a disconnected retracted position, said means for detecting and reporting the active position of a plate are in this case (to give a non-exhaustive example) electrical means.

For this purpose, the rear, non-split part of the front printed circuit board 50 comprises, for each front slot 38, a conducting contact track (not shown in the figures) with which there engages the lower face of a hook 36 of a separating plate 34 when the latter is present.

The base plate 16, 16inf may for example be insulating or insulated, and the plate 34 may for example be made of metal, its front hook 36 in electrical contact with a grounded track.

At the rear, the backing plate 46 comprises a rear printed circuit board 51 which has in particular on its upper face a series of x small elastic contact detecting clamps 110, each connected to a conducting detecting track (not shown) belonging to the rear board 51.

Each detecting clamp 110 takes the rear hook 36 of a plate 34 when the latter is present in the active position of a separating partition.

The metal plate 34 thus establishes electrical contact between the grounded track of the front printed circuit board 50 and the clamp 110 of the rear board 51.

Each separating plate 34 in the active position therefore connects the clamp 110 which receives it to electrical ground, thus giving rise to a signal denoting the presence of the plate 34 which is then transmitted and analyzed by the electronic control unit to which the rear printed circuit board 51 is connected, particularly by means of connectors 112 and associated wiring (not shown).

Similarly, the sensor units 66 of the front printed circuit board 50 are connected to the electronic control unit in order to transmit signals representing the presence or absence of a box B in the forwardmost position, and signals representing the ejection of this box as its lower face leaves the sensor during its ejection.

The rear board 51 also comprises sensor units 114 positioned level with the rear holes 44 in order to detect the insertion or positioning, through the open rear longitudinal end of a channel C, of each box into this channel.

The signals thus formed by the sensors 114 can also be analyzed by the central electronic control unit to control the filling of the channels.

The central control unit may of course also be connected to the various racks P belonging to one or more devices 10 linked up in a single dispensing system.

As a variant (not shown) of this first embodiment, the separating plates may permanently be fitted on a rack on which they slide transversely to occupy a predetermined active position of use. Unused plates are then stored, stacked transversely side by side out of the way on one or both sides of the rack.

As a variant (not shown), each rack may comprise means for propelling the boxes longitudinally forward, such as belts or the like on which the boxes rest.

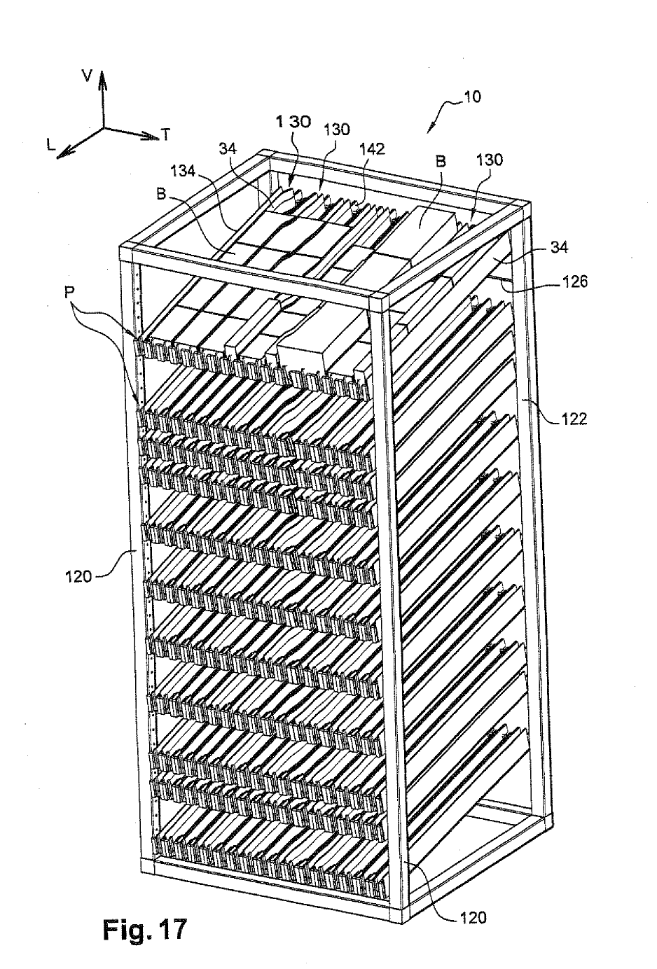

The second embodiment and its variants, illustrated in FIG. 17 onward will now be described.

In a known and traditional manner, the device 10 here comprises a frame in is the shape of a right-angled parallelepiped made of tubes connected together at the eight corners or angles. The frame comprises, among other things, two front vertical uprights 120 and two rear vertical uprights 122 which have the same function as the side plates 22, and between which there extend pairs of linked front 124 and rear 126 horizontal crossmembers (not shown in detail), or alternatively inclined plates forming shelves.

Each pair of crossmembers 124, 126, with the rear crossmember 126 higher than the front crossmember 124, constitutes a supporting surface, inclined in the forward direction, on which a series of adjacent longitudinal modules 130 rest to form a rack P.

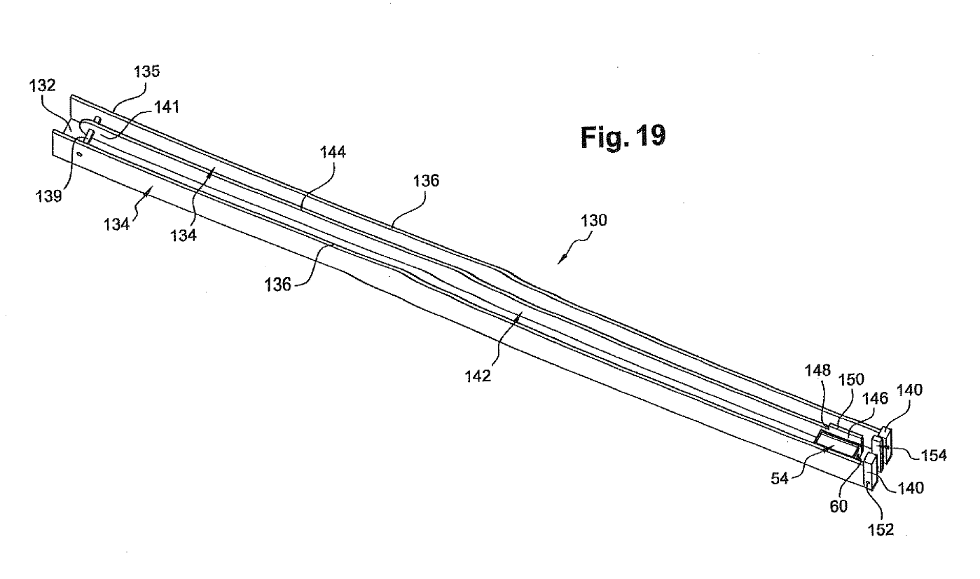

Each module 130 shown in FIG. 19 is U-shaped in transverse section and comprises a longitudinal lower plate 132 and two parallel and opposite vertical side wings 134. The side wings 134 are bounded vertically at the top by their flat coplanar longitudinal upper edges 136 which perform the same flat base function as the upper face 17 of the plates 16 in the first embodiment, and on which the lower faces of the boxes rest.

All the modules are identical and all the upper edges 136 of each rack P are thus coplanar and inclined to form surfaces that slope, from the rear to the front, at the angle alpha relative to the horizontal. A box B placed on at least two edges 136 is thus able to slide by gravity down toward the front in the general longitudinal direction L.

As can be seen in FIGS. 17, 18 and 19, each side wing 134 can be provided, along its outer side face 135, with a vertical longitudinal separating plate 34.

Each separating plate is fixed removably disconnectably and extends vertically above the plane of the upper edges 136.

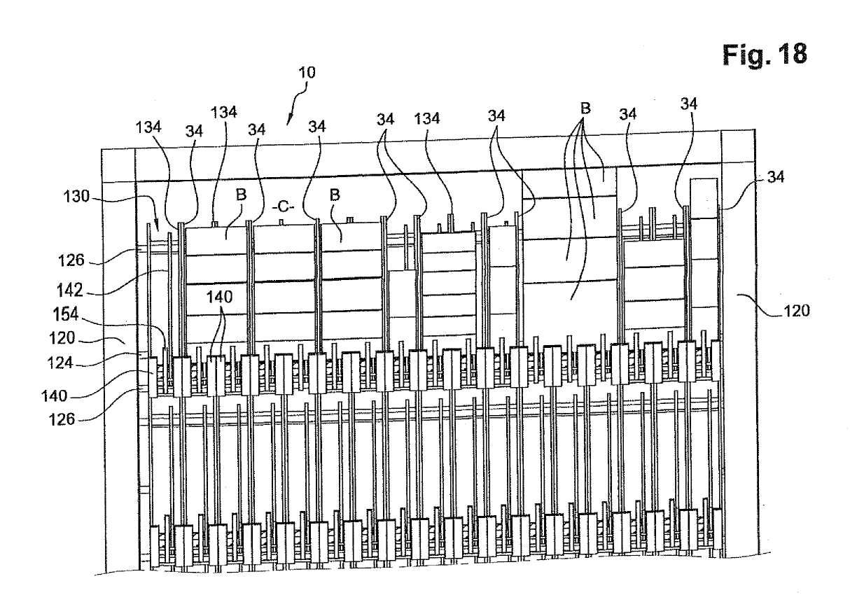

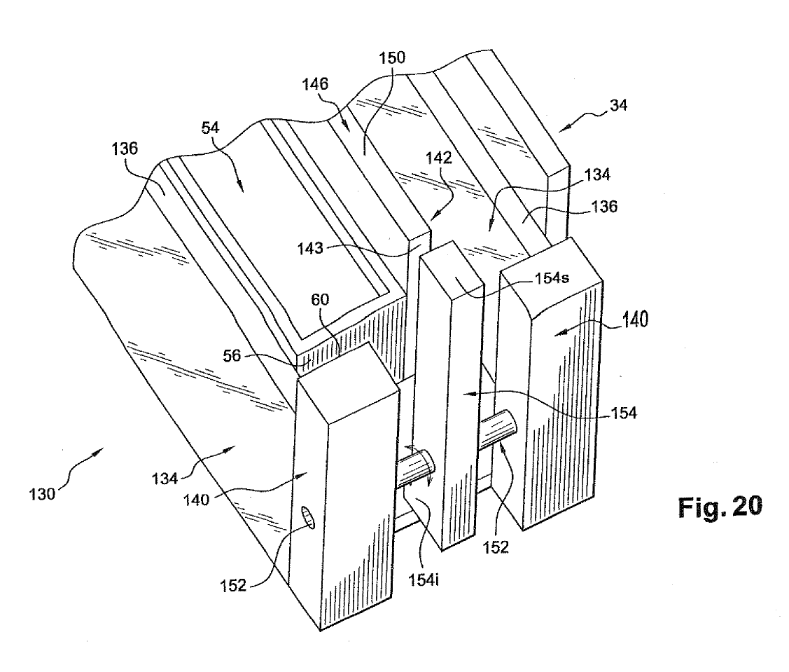

Each module 130 may for example be able to accept a separating partition 34 along the outer face 135 of its side wing seen on the right-hand side when viewing for example FIGS. 18 and 20

The separating plates 34 thus divide the space above the plane of the upper edges 136 into a series of inclined longitudinal channels C, or corridors, each of which can house a series of longitudinally adjacent boxes in single file.

Depending on whether or not a module 130 is provided with a separating side plate 34, a rack P can be created with adjacent corridors C of different transverse widths

As in the first embodiment, the device is equipped with means (not shown) for showing whether or not a separating plate 34 is present, and for supplying corresponding electrical signals processable by an electronic dispensing control unit (not shown) connected to the device 10, or to several devices 10 assembled together

These means may be electrical, optical, magnetic or of any other type.

At its forward longitudinal end, each side wing 134 is provided with a fixed vertical front stop bar 140 which is vertically above the plane of the upper edges 136 by a distance of for example approximately 15 mm.

The forwardmost box of each row of boxes contained in one channel C thus bears longitudinally, forward and downward, by gravity, against their portions of the stop bars 140 that extend vertically across the front open end of the corresponding channel C.

Each module 130 comprises a movable ejector plate 142 which is a vertical central plate parallel to the side wings, and which is mounted in such a way as to pivot, in the vicinity of its rear longitudinal end 141, about a horizontal pivot axis 139 running transversely between the two side wings 134.

The front longitudinal end of the upper edge 144 includes a raised portion 146 with a vertical rear end 148 forming a rearward-facing stop, the function of which will be explained later.

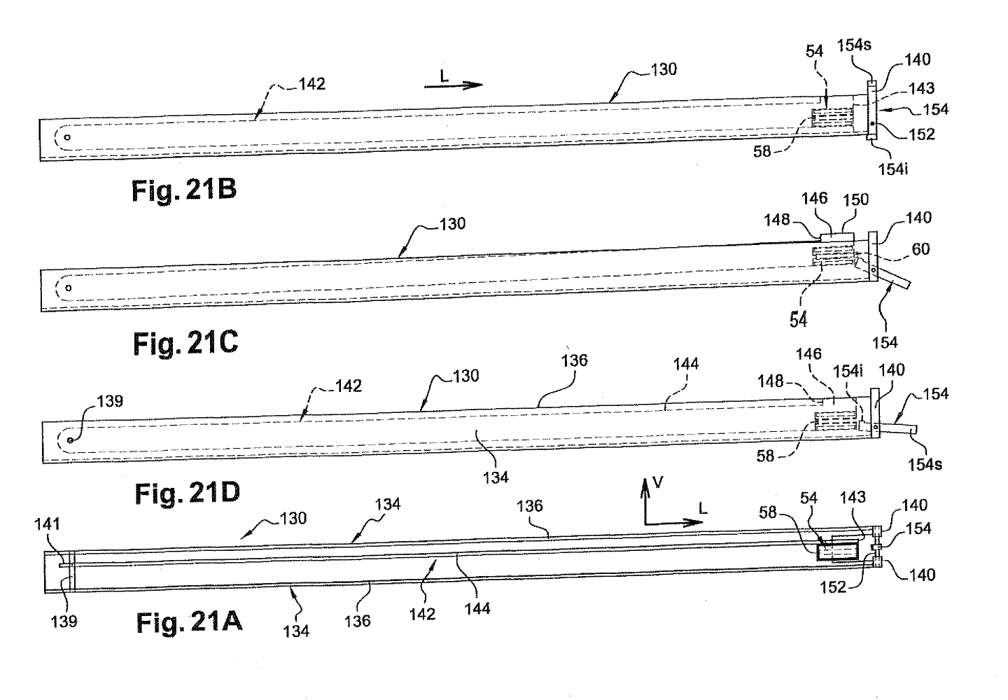

In its lowered rest position (FIG. 21B), the upper edge 144 of the ejector plate 142 is positioned below, or at the most in the same plane as, the is coplanar upper edges 136.

In its raised ejection position (FIG. 21C), at least the upper horizontal edge 150 of the raised portion 146 is vertically higher than the plane of the edges 136 and able to act on the lower face of a box B which is present in the channel and resting against the stops 140.

Each ejector plate 142 has in the vicinity of its front longitudinal end an actuator which in this case again is an electromagnet 54, the axis of which is oriented longitudinally, and which comprises among other things a longitudinal cylindrical coil body 56 and a movable core or rod 58 extending forward longitudinally. The free end section 60 of the rod 58 can be extended longitudinally forward in the working position, or retracted longitudinally rearward in the rest position.

As the figures show, when the coil of an electromagnet 54 is energized so that the movable rod 58 is extended longitudinally forward into its working position, at least its free front end section 60 projects longitudinally forward beyond the vertical front end edge 143 of the ejector plate 142 on which the electromagnet 54 is mounted.

The dimensions of the electromagnet 54 are such that it can “rise” vertically between the side wings 134. In such a “raised” position of the electromagnet 54, the vertical rear end 148 acts as a stop for the next box which is arrested by this stop and is temporarily unable to reach the fixed stops 140.

Besides an electromagnet 54, the controlled ejector means ejecting a forwardmost box contained in a channel C—in order to pass it vertically over the transverse stops 140 and eject it from a channel C—comprise a transverse motorized drive bar 152 designed to act on the free end section 60 of each movable rod 58 of each electromagnet 54 in the extended or working position to bring about a vertical generally upward movement of this movable rod 58.

The motorized bar 152 is a transverse drive bar rotated about its axis (by an ejection control motor not shown in the figures) between an angular rest position and an angular working position, and carries a series of radial levers 154 coupled rotationally to the drive bar 152 in such a way that each corresponds to one module and is able to act on the movable member in the working position.

The bar 152 and the radial levers 154 can be turned in either direction through an angular stroke of a little over 90 degrees, between a rest position, in which all levers are vertical (FIGS. 19, 20 and 21B) and act as tall vertical stops, and a roughly horizontal active ejection position.

It is of course possible to provide means (not shown) for turning all the bars 152 of the individual racks P simultaneously.

By its very construction as shown in the figures, each component 154 not only acts as a radial ejector lever but also as a retractable additional stop for retaining the forwardmost box when this component is in the vertical rest position shown for example in FIGS. 20 and 21B.

For this purpose, each radial lever has a lower ejector arm 154i designed to act on the free end section 60, and therefore indirectly on the lower face of the box, and an upper arm 154s acting as a retractable stop that is longer than the lower arm 154i.

The height of this arm 154s which acts as a retractable stop may for example be an additional 10-15 mm or so above the fixed stops 140. This gives a series of tall stops 154s offering very secure retention of the forwardmost boxes without increasing the total functional height of a rack P, since in order to eject the forwardmost box the stop 154s is retracted and then the box only has to pass over the fixed stops 140.

The stops 154s are particularly important for retaining the forwardmost boxes during filling of the corridors C, when these boxes arrive with considerable kinetic energy against the retaining stops.

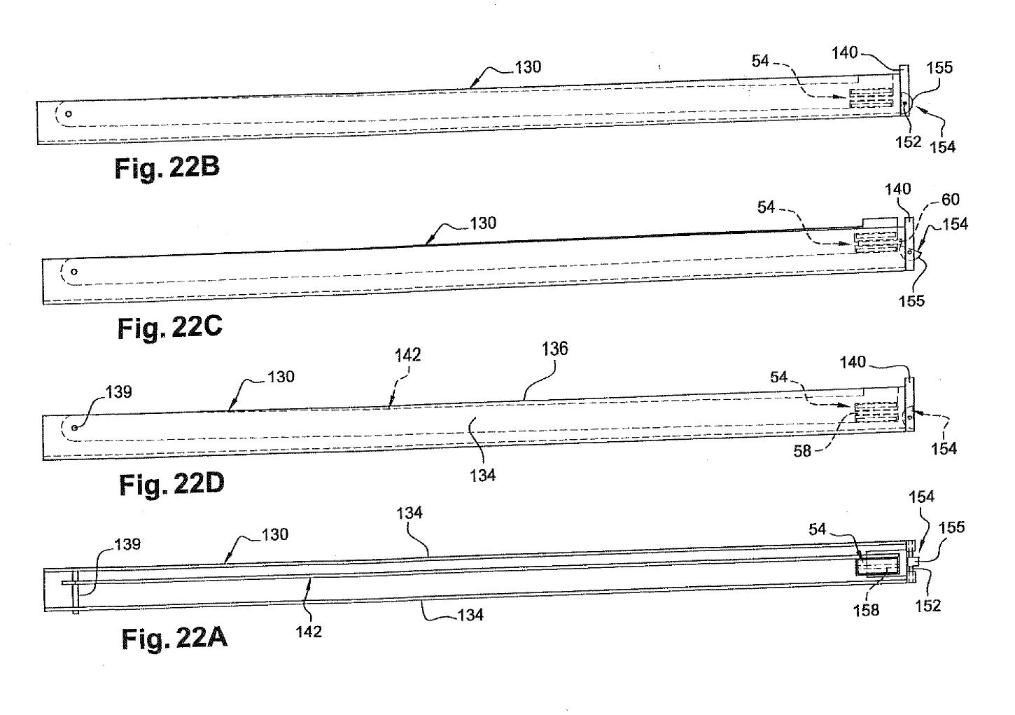

In the variant illustrated in FIGS. 22A-22D, one face 155 of each radial lever 154 is made in the form of a convex rounded cam profile and it is therefore no longer necessary to reverse the direction of rotation of the drive bar to move from the ejection position to the rest position, since the cam levers 154-155 rotate clockwise when viewing the figures.

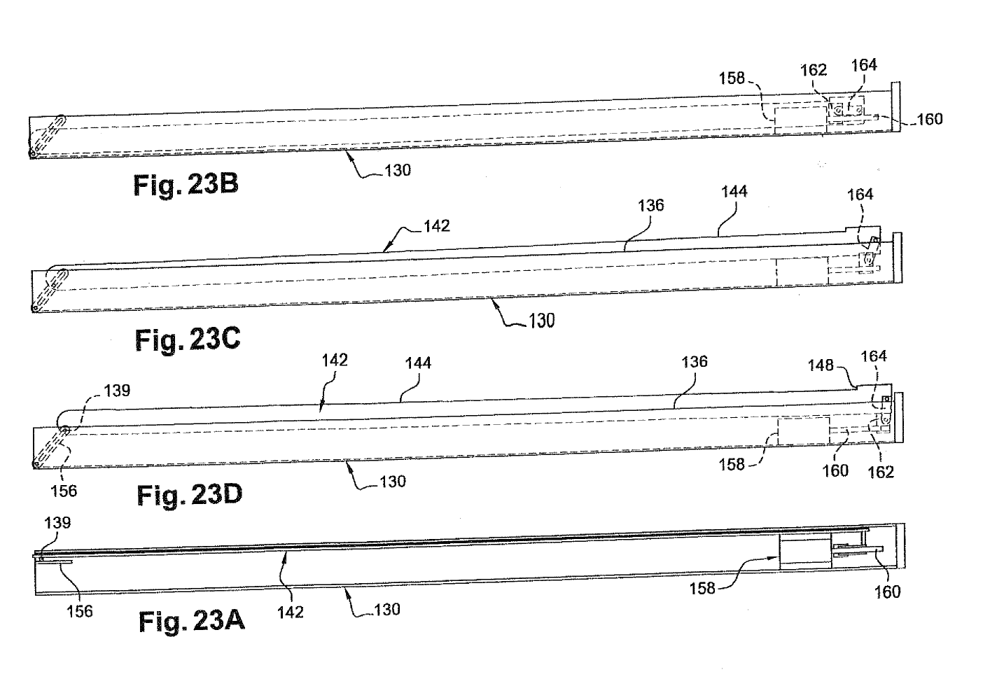

In the variant illustrated in FIGS. 23A-23C and 23E, the ejector plate 142 is hinged at its rear end by a rear lever 156 on which it can pivot and slide and is driven individually by an electric motor 158 mounted in the vicinity of the front longitudinal end of the plate 142 with its threaded output shaft 160, which is of longitudinal orientation, screwed into a nut 162, with which it forms a screw-and-nut system.

The nut 162 is attached to a forward hinged lever 164. The rotation of the motor 158 in either direction causes the separating plate 142 to either rise or descend.

It is of course possible to simultaneously control all the motors corresponding to those channels C from which products are to be ejected.

As can be seen by comparing FIGS. 23C and 23E, in the raised ejection position, only the front upper part of the ejector plate 142 projects vertically above the upper edges 136, whereas, because of the design with the rear 156 and front 164 levers, the whole ejector plate 142 can be moved generally upward so that it acts as a separating plate in this extreme raised position where it remains “locked” by the screw-and-nut system 160-162, even when the electric motor 158 is stopped.

With such a module 130 it is therefore possible to dispense with the optional separating side plates 34 described earlier and instead to use their central movable plates 142 which then function as controlled movable separating plates, each driven by individual motorized drive means consisting of the motor 158, between its active raised and retracted lowered positions.

One module 130 can thus be a module used for its “separator” function or for its “ejector” function.

The electrical operation of a motor 158 reveals whether the central plate 142 is in the raised separating position and so provides a signal representing this position.

In a variant which is not illustrated, the upward movement of a plate 142 is combined with a transverse movement of this plate, generally parallel to its plane, this combination of movements being obtained by plate guide ramps on the U-shaped module 130.

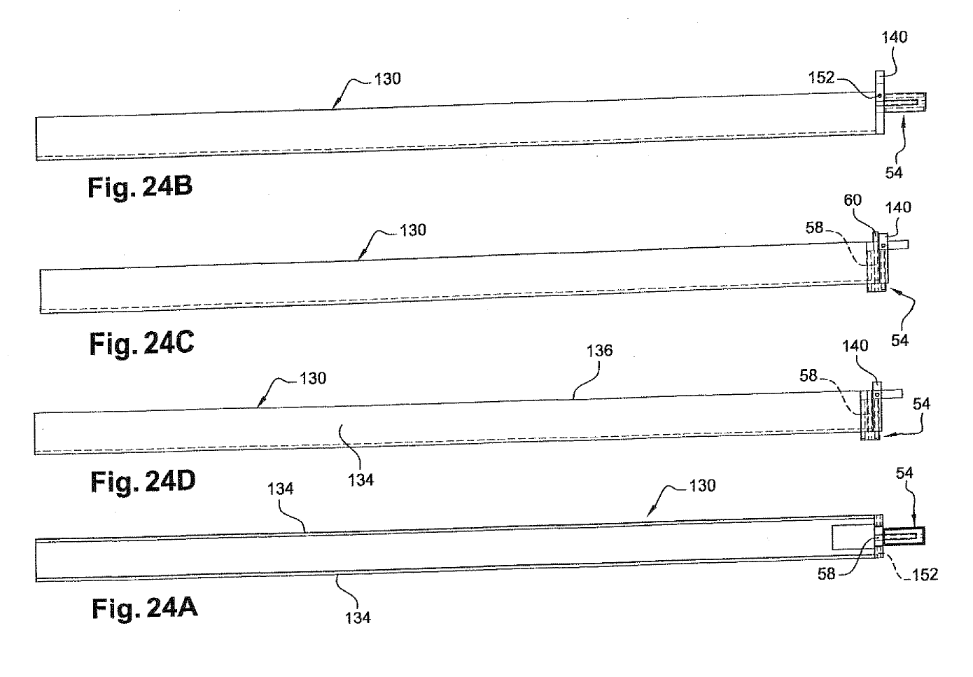

In the variant illustrated in FIGS. 24A-24C, the module 130 has no central ejector plate, and each module has an electromagnet 54 mounted rotatably on the common drive bar 152.

At rest, each electromagnet is horizontal with its rod 58 withdrawn. The latter can project toward the rear so that its free end section extends below the lower face of the forwardmost box standing above the module 130. When the rod is extended, clockwise rotation causes the free end section 60 to lift the box over the fixed vertical stops 140 thereto.

Other variants are possible, though not illustrated. Each separating “partition” between two adjacent channels can take the form of one or more stretched wires in place of an actual separating plate.

Each electromagnet can be replaced by, for example, an actuator of equivalent function such as a single-acting or double-acting pneumatic or hydraulic cylinder, or by an actuator based on a shape-memory wire.

1. A device (10) for automatically dispensing and ejecting products (B) stored in parallel longitudinal rows, that comprises at least one rack (P) comprising:
a series of transversely adjacent channels (C), each able to hold a row of products (B), all in the same plane as each other, each separated from its neighbor or neighbors by a longitudinal partition (34) perpendicular to said plane, and each having a flat base on which the products rest;
stop means (40, 140) at the forward longitudinal end of each channel against which the forwardmost product in each row is retained by longitudinal abutment;
and a series of controlled ejector means, of which each corresponds to one channel and is able to act on said forwardmost product in order to pass it vertically over said stop means (40, 140) for its ejection from the channel;
which device is characterized in that each ejector device comprises:
a movable ejector plate (52, 142) capable of acting, directly or indirectly, on the lower face of at least said forwardmost product in order to eject it;
and an actuator (54) which corresponds to each channel (C), is connected mechanically to said ejector plate (52, 142) and comprises a movable member (60) that can be controlled between a rest position and a working position in order to eject it.

2. The device (10) as claimed in claim 1, characterized in that each ejector device comprises a motorized drive member (68, 154) able to act on said movable member (60) in the working position in order to produce a generally upward vertical movement of the ejector plate (52, 142).

3. The device (10) as claimed in claim 2, characterized in that:
the body of the actuator (54) is connected to the ejector plate (52, 142);
and the motorized drive member (68, 154) is able to act on said movable member (60) in the working position to produce a generally upward vertical movement of the actuator (54), and hence of the ejector plate (52, 142) to which the actuator (54) is mechanically connected.

4. The device (10) as claimed in claim 3, characterized in that the movable ejector plate (52) is a plate generally parallel to said plane with an upper face capable of acting, directly or indirectly, on the lower face of at least said forwardmost product.

5. The device (10) as claimed in claim 4, characterized in that the movable ejector plate is a flexible plate (52) that is elastically deformable between a low or rest position, to which it is returned elastically, and a high or ejection position, in which it extends upward vertically.

6. The device (10) as claimed in claim 5, characterized in that the body of the actuator (54) is mounted on the upper face (53) of the flexible ejector plate (52), and in that the upper face (64) of the casing (62) of the actuator (54) is able to act on the lower face of said forwardmost product, by extending upward, notably through a corresponding window (42) facing it through a base plate (16) common to all the channels (C) of a rack (P).

7. The device (10) as claimed in claim 3, characterized in that the movable ejector plate (142) is a plate that is perpendicular to said plane and whose upper longitudinal edge is able to act on the lower face of at least said forwardmost product in order to eject it.

8. The device (10) as claimed in claim 7, characterized in that:
each intermediate partition is a separating plate (142) mounted movably between a high active position of separation in which it projects vertically to separate two adjacent channels and a low retracted position;
each movable separating plate (142) is able to form a movable ejector plate whose upper longitudinal edge is able to act on the lower face of at least said forwardmost product in order to eject it; and
said motorized means are able to drive each separating plate acting as an ejector plate between its low retracted position and a high ejection position.

9. The device (10) as claimed in claim 8, characterized in that said high ejection position is an intermediate position between said low retracted position and said high separating position.

10. The device (10) as claimed in claim 1, characterized in that the actuator (54) is an electromagnet whose movable core (60) is controllable between a withdrawn rest position and an extended working position in which it can be acted on by the motorized drive member.

11. The device (10) as claimed in claim 2, characterized in that the motorized drive member (68, 152) is a member common to all the ejector means which is able to act simultaneously on all of said movable members (60) which are in the working position, in order to simultaneously eject said forwardmost products contained in the corresponding channels.

12. The device (10) as claimed in claim 11, characterized in that the motorized actuating member is a transverse drive bar (68) that is driven, by an ejection control motor, between a low or rest position and a high or ejection position in which it acts simultaneously on said movable members (60) in the working position.

13. The device (10) as claimed in claim 7, characterized in that the motorized actuating member is a transverse drive bar (152) that is rotated about its axis, by an ejection control motor, between an angular rest position and an angular working position, and that carries a series of radial levers (154) coupled in rotation to the drive bar and each able to act on a movable member (60) in the working position of a corresponding channel.

14. The device (10) as claimed in claim 13, characterized in that each radial lever (154) comprises an arm (154i) which, in the angular rest position of the drive bar (152), acts as a stop located at the forward longitudinal end of each channel (C), against which the forwardmost product of each row is retained in longitudinal abutment.
